(19) United States
(12) Patent Application Publication
(10) Pub. No.: US 2005/0201077 A1
(43) Pub. Date: Sep. 15, 2005

(54) Backlight module with transflective layer at light source

(75) Inventor: Kun-Jung Tsai, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/046,955

(22) Filed: Jan. 31, 2005

(30) Foreign Application Priority Data
Mar. 9, 2004 (TW) 93106166

(51) Int. Cl. G01D 11/28

(52) U.S. Cl. 362/26; 362/606

(57) ABSTRACT

A backlight module (20) includes a light guide plate (20), a light source (21), and a translective film (22). The light guide plate includes a bottom surface (26) and an opposite light emitting surface (25). A recess (27) is defined in the light guide plate at the bottom surface, and contains the light source. The transflective element is disposed between the light source and the recess, to control the intensity of the light beams entering the light guide plate. The transfective film negates excessively high intensity of light beams at regions near the light source. Thus the backlight module provides uniform illumination.

### BACKGROUND OF THE INVENTION

1. Field of the Invention

The present invention relates to backlight modules used in liquid crystal displays, and particularly to backlight modules having a light source accommodated within a light guide plate.

2. Description of the Prior Art

A backlight module is a key component in a transmissive type or a transflective type liquid crystal display. The backlight module is usually mounted under a liquid crystal display panel for supplying light beams thereto. The backlight module generally includes a light source and a transparent light guide plate. The light guide plate is used for guiding the light beams emitted by the light source to uniformly illuminate the liquid crystal display panel. Most backlight modules have the light source disposed adjacent the light guide plate. This configuration means that the backlight module occupies a relatively large volume, because the light source takes up space in addition to the space occupied by the light guide plate.

A Japanese patent application publication No. 2002-245823 published on Aug. 30, 2002 discloses a backlight module having a relatively small volume. Referring to FIG. 6, the backlight module 100 includes a light guide plate 10, a light source 11, and a light deflection element 12. The light guide plate 10 has a bottom surface 15, a light emitting surface 14 opposite to the bottom surface, and three incident surfaces 13. The incident surfaces 13 cooperate to define a recess 16 of the light guide plate 10 at the bottom surface 15. In assembly, the light source 13 is fixed in the recess 16. Light beams from the light source 13 enter the light guide plate 10 through the incident surfaces 13, emit from the light emitting surface 14, and propagate through the light deflection element 12. The light deflection element 12 adjusts the transmission of the light beams to a certain direction.

Because the backlight module 100 has the light source 11 within the light guide plate 10, the backlight module 100 has approximately the same volume as that of the light guide plate 10. That is, compared to conventional backlight modules, the backlight module 100 has a smaller volume. However, the light propagating distance between the light source 11 and various positions on the light emitting surface 14 varies greatly. That is, the intensities of light beams arriving at the light emitting surface 14 differ greatly. In particular, at a position immediately above the light source 11, the intensity of light beams is excessively strong. Thus the backlight module 100 provides excessively bright areas, and cannot provide uniform illumination for a liquid crystal display panel.

### SUMMARY OF THE INVENTION

Accordingly, an objective of the present invention is to provide a backlight module which has a small volume and which outputs light beams uniformly.

In order to achieve the above objective, a backlight module of the present invention comprises a light guide plate, a light source, and a transflective element. The light guide plate comprises a bottom surface and an opposite light emitting surface. A receptacle is defined in the light guide plate at the bottom surface, and contaius the light source. The transflective element is disposed between the light source and the recess, for reducing the intensity of light beams entering the light guide plate thereat.

The present invention employs the transflective element to change the intensity of the light beams. Unlike in the prior art, the transflective film negates excessively high intensity of light beams at regions near the light source. Thus the backlight module provides uniform illumination.

Other objects, advantages and novel features of the present invention will be apparent from the following detailed description of exemplary embodiments thereof with reference to the attached drawings, in which:

### BRIEF DESCRIPTION OF THE DRAWINGS

FIG. 1 is an exploded, isometric view of a backlight module according to a first embodiment of the present invention;

FIG. 2 is a cross-sectional view taken along line II-II of FIG. 1;

FIG. 3 is a cross-sectional view of part of a backlight module according to a second embodiment of the present invention;

FIG. 4 is an exploded, isometric view of a backlight module according to a third embodiment of the present invention;

FIG. 5 is a cross-sectional view of part of a backlight module according to a fourth embodiment of the present invention; and

FIG. 6 is a schematic, exploded cross-sectional view of a conventional backlight module.

### DETAILED DESCRIPTION OF THE INVENTION

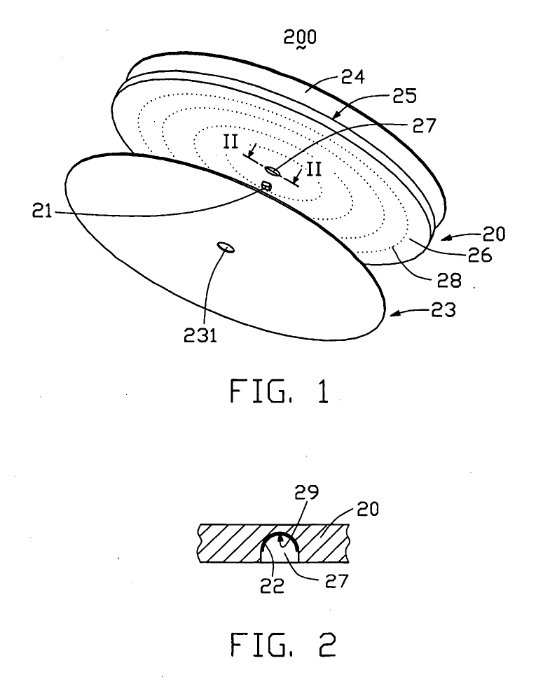

A backlight module 200 according to a first embodiment of the present invention is shown in FIG. 1 and FIG. 2. FIG. 1 is an exploded view, and FIG. 2 is a partial cross-sectional view. The backlight module 200 includes a plate-like light guide member 20, a point light source 21, a transflective element 22, a diffusion plate 24, and a reflection plate 23. The light guide plate 20 comprises a bottom surface 26 and an opposite light emitting surface 25. The reflection plate 23 is disposed adjacent the bottom surface 26, and the diffusion plate 24 is disposed adjacent the light emitting surface 25. A generally arch-shaped recess 27 is defined in a middle of the light guide plate 20 at the bottom surface 26, to contain the light source 21. In particular, an upper portion of the recess 27 defines a hemispherical shape. The transflective element 22 is preferably a transflective film, which is disposed on an uppermost surface of the light guide plate 20 in the recess 27. The reflection plate 23 has a though hole 231 corresponding to the recess 27, for mounting the light source 21 therein. A dot pattern 28 is formed on the bottom surface 26. The dot pattern 28 defines a series of concentric circles encircling the light source 21, and functions as a primary difusser.

In operation, the transflective film 22 reflects a portion of light beams received from the light source 21, and thus reduces the quantity of light beams that directly enter the light guide plate 20. After that, the reflection plate 231 reflects a portion of the reflected light beams into the light guide plate 20. The cooperation of the transflective film 22 with the reflection plate 231 enables peripheral regions of the light guide plate 20 to receive more light beams than the otherwise would be the case. Thus excessively strong brightness in regions right above the light source 21 is avoided, and brightness at regions further from the light source 21 is enhanced.

Furthermore, a reflection ratio of the transflective film 22 is not uniform. The reflection ratio is highest at a topmost portion 29 of the light guide plate 20 bounding the recess 27, and becomes progressively lower with increasing distance away from the topmost portion 29. Accordingly, the transreflective film 22 allows fewer light beams to pass therethrough at the topmost portion 29 compared to other positions, and thus helps achieve more uniform distribution of light beams entering the light guide plate 20 through the transflective film 22.

Compared with the prior art, the transflective film 22 reduces transmission of light beams at positions right above the light source 21 where the intensity of the light beams is particularly high. Furthermore, with the utilization of the reflection plate 231, the regions of the light guide plate 20 distal from the light source 21 receive more light beams. Thus the backlight module 200 provides more uniform illumination.

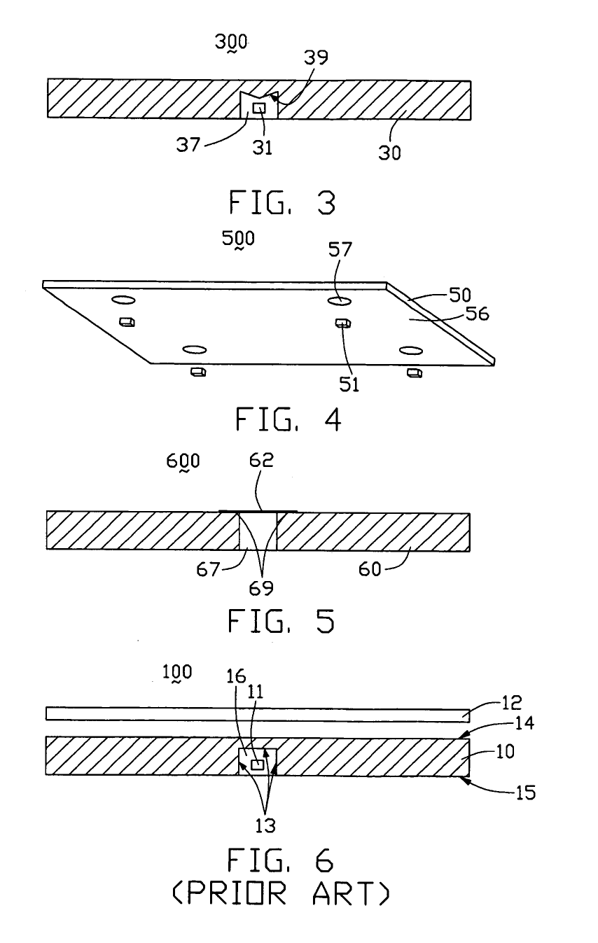

Referring to FIG. 3, part of a backlight module 300 according to the second embodiment of the present invention is shown. A top portion 39 of a light guide plate 30 bounding a recess 37 is boss-shaped, and a transflective film (not shown) is disposed on the top portion 39. In operation, a portion of light beams emitted fiom a light source 31 is reflected by the trasnsflective film. Because the top portion 39 is boss-shaped, the refected light beams transmit to regions of the light guide plate 30 distal from the light source 31. Thus what is otherwise relatively poor brightness of the distal regions is enhanced.

Referring to FIG. 4, a backlight module 500 according to the third embodiment of the present invention is shown. The backlight module 500 comprises a light guide plate 50 in the shape of a flat, rectangular sheet Four recesses 57 are defined at four corners of a bottom surface 56 of the light guide plate 50, and four light sources 51 are arranged in the recesses 57 respectively. The backlight module 500 is most suitable for providing uniform illumination for a larger sized display requiring a plurality of light sources.

Referring to FIG. 5, a backlight module 600 according to the fourth embodiment of the present invention is shown. The backlight module 600 comprises a light guide plate 60, which defines a central through hole 67. The through hole 67 in effect replaces the recess 27 of the backlight module 200, and contains a light source (not shown). A transflective element 62 is disposed on a top portion 69 of the light guide plate 60, such that the transflective element 62 covers the through hole 67.

All the abovementioned backlight modules 200, 300, 500, 600 utilize one or more recesses 27, 37, 57 or a through hole 67 to contain the respective light source(s), and to employ a transflective film thereat. The transflective film negates excessively high intensity of light beams at regions near the light source and, with use of a reflection plate, enhances the otherwise relatively low intensity of light beams at regions distal from the light source. Thus the backlight modules 200, 300, 500, 600 provide more uniform illumination.

In alternative embodiments, the transflective element is not limited to being a transflective film. Other means which achieve the same light intensity controlling function can be employed. For example, surfaces of the light guide plates 20, 30, 50 in the recess 27, 37, 57 can be roughened. In cases where higher brightness is required,

each point light source can be replaced by a linear light source such as a CCFL (Cold Cathode Fluorescent Lamp).

It is to be further understood that even though numerous characteristics and advantages of the present invention have been set out in the foregoing description, together with details of the structure and function of the invention, the disclosure is illustrative only, and changes may be made in detail, especially in mars of shape, size, and arrangement of parts within the principles of the invention to the full extent indicated by the broad general meaning of the terms in which the appended claims are expressed.

1. A backlight module, comprising:
a light source;
a light guide plate comprising a bottom surface and an opposite light emitting surface, and a receptacle at the bottom surface containing the light source; and
a transflective element disposed in the receptacle between the light source and the light guide plate, for reducing the intensity of light beams entering the light guide plate thereat.

2. The backlight module as recited in claim 1, wherein the transflective element has different reflection ratios at different portions thereof.

3. The backlight module as recited in claim 2, wherein a reflection ratio of the transflective element progressively decreases with increasing distance away from a position thereof directly above the light source.

4. The backlight module as recited in claim 1, wherein the receptacle comprises a recess, and a portion of the light guide plate at an inmost end of the recess is boss-shaped.

5. The backlight module as recited in claim 1, wherein receptacle comprises a through hole.

6. The backlight module as recited in claim 1, further comprising a dot pattern formed on the bottom surface of the light guide plate.

7. The backlight module as recited in claim 1, further comprising a diffusion plate disposed adjacent the light emitting surface.

8. The backlight module as recited in claim 1, further comprising a reflection plate disposed adjacent the bottom surface of the light guide plate.

9. The backlight module as recited in claim 8, wherein the transflective element has different reflection ratios at different portions thereof.

10. The backlight module as recited in claim 9, wherein a reflection ratio of the transflective element progressively decreases with increasing distance away from a position thereof directly above the light source.

11. The backlight module as recited in claim 8, wherein the receptacle comprises a recess, and a portion of the light guide plate at an inmost end of the recess is boss-shaped.

12. The backlight module as recited in claim 8, wherein receptacle comprises a through hole.

13. The backlight module as recited in claim 8, further comprising a dot pattern formed on the bottom surface of the light guide plate.

14. The backlight module as recited in claim 8, further comprising a diffusion plate disposed adjacent the light emitting surface.

15. A backlight module, comprising:
a light source;
a light guide member disposed next to said light source, and comprising a surface to accept light from said light source into said light guide member and a light emitting surface for emitting said light out of said light guide member; and
a transflective element disposed between said light source and said light emitting surface of said light guide member so as to proportionally reduce intensity of said light transmitted from said light source to a projective portion of said light source on said light emitting surface.

16. The backlight module as recited in claim 15, wherein said transflective element is a transflective film attached to said surface of said light guide member for accepting said light from said light source.

17. The backlight module as recited in claim 15, wherein said light guide member comprises a boss-shaped portion disposed between said transflective element and said light emitting surface to control transmission directions of said light after said light encounters said transflective element.

18. A backlight module, comprising:
a light guide member comprising a surface to accept light transmitted into said light guide member and a light emitting surface for emitting said light out of said light guide member;
a light source used to provide said light toward said light guide member, said light source located next to a portion of said light guide member where a distance between said light source and said light emitting surface is shorter than thickness of other portions of said light guide member; and
a transflective element disposed between said light source and said light emitting surface of said light guide member so as to reduce intensity of said light passing through said transflective element.

19. The backlight module as recited in claim 18, wherein said transflective element is a transflective film attached to said surface of said light guide member for accepting said light of said light source.

20. The backlight module as recited in claim 19, wherein said transflective element and said light source are received in a recess of said light guide member.
